(19) United States
(12) Patent Application Publication
(10) Pub. No.: US 2025/0062831 A1
(43) Pub. Date: Feb. 20, 2025

(54) OPTICAL DEVICE, OPTICAL RECEIVER, AND OPTICAL TRANSCEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/767,478

(22) Filed: Jul. 9, 2024

(30) Foreign Application Priority Data
Aug. 14, 2023 (JP) 2023-132138

(51) Int. Cl. H04B 10/40; G02B 6/122; H01S 3/067; H01S 3/10; H04B 10/61; H04B 10/64

(52) U.S. Cl. CPC H04B 10/40; G02B 6/1228; H01S 3/06712; H01S 3/06745; H01S 3/10061; H04B 10/614; H04B 10/6166; H04B 10/64

(57) ABSTRACT

An optical device includes a first edge coupler that is connected to a polarization multiplexer-demultiplexer and that makes contact with an end face and a second edge coupler that is connected to an optical hybrid circuit and that makes contact with the end face. The optical device includes a first taper portion that directs light from the end face and that is contained in the first edge coupler and a second taper portion that directs light from the end face and that is contained in the second edge coupler. The second taper portion has a structure in which a taper angle of the second taper portion with respect to the end face is smaller than a taper angle of the first taper portion with respect to the end face.

### CROSS-REFERENCE TO RELATED APPLICATION

This application is based upon and claims the benefit of priority of the prior Japanese Patent Application No. 2023-132138, filed on Aug. 14, 2023, the entire contents of which are incorporated herein by reference.

### FIELD

The embodiments discussed herein are related to an optical device, an optical receiver, and an optical transceiver.

### BACKGROUND

FIG. 11 is an illustration illustrating an example of a conventional light chip 100. The light chip 100 illustrated in FIG. 11 is, for example, a light IC chip including an optical receiver 110 of a digital coherent function. The optical receiver 110 includes a first edge coupler (EC) 111 that is arranged in a signal light port to which signal light is input, a second EC 112 that is arranged in a local oscillation light port to which local oscillation light is input, and a polarization beam splitter (PBS) 113. The optical receiver 110 includes a polarization rotator (PR) 114, a first optical hybrid circuit 115A, a second optical hybrid circuit 115B, first to fourth photo diodes (PDs) 116A to 116D, and first to fourth output ports 117A to 117D. For example, the second EC 112 and the first optical hybrid circuit 115A, the second EC 112 and the second optical hybrid circuit 115B, the first EC 111 and the PBS 113 are connected with optical waveguides, such as Si waveguides.

The first EC 111 of the signal light port is formed on a chip end face D11 that is a side surface end in the light chip 100 and is, for example, an EC of the port that connects to the first optical fiber F11 to which a light signal is input. Note that the signal light port is exposed on the chip end face D11 of the light chip 100 by forming a wafer into a chip. The second EC 112 of the local oscillation light port is formed on the chip end face D11 of the light chip 100 and is, for example, an EC of the port that connects to the second optical fiber F12 to which local oscillation light from a light source is input. Note that the local oscillation light port is exposed on the chip end face D11 of the light chip 100 by forming a wafer into a chip.

The PBS 113 separates received light that is the signal light that is input from the first EC 111 into two intersecting polarized states, for example, received light of a X-polarized wave component that is a transverse electric (TE) polarized wave and a Y-polarized wave component that is a transverse magnetic (TM) polarized wave. The PBS 113 outputs the received light of the X-polarized wave component to the first optical hybrid circuit 115A. Furthermore, the PR 114 makes a polarized wave rotation on the received light of the Y-polarized wave component from the PBS 113 by 90 degrees, to convert the received light into received light of the Y-polarized wave component after the polarized wave rotation and outputs the received light to the second optical hybrid circuit 115B.

The first optical hybrid circuit 115A interferes the received light of the X-polarized component with the local oscillation light and acquires light signals of an I component and a Q component. Note that the I component is an in-phase component and the Q component is a quadrature phase component. The first optical hybrid circuit 115A outputs the light signal of the I component in the received light of the X-polarized component to the first PD 116A. The first optical hybrid circuit 115A outputs the light signal of the Q component in the received light of the X-polarized component to the second PD 116B.

The second optical hybrid circuit 115B interferes the received light of the Y-polarized component with the local oscillation light and acquires light signals of an I component and a Q component. The second optical hybrid circuit 115B outputs the light signal of the I component in the received light of the Y-polarized component to the third PD 116C. The second optical hybrid circuit 115B outputs the light signal of the Q component in the received light of the Y-polarized component to the fourth PD 116D.

The first PD 116A electrically converts the light signal of the I component of the X-polarized component from the first optical hybrid circuit 115A and adjusts the gain and then outputs an electric signal after the adjustment of the gain to the first output port 117A. The second PD 116B electrically converts the light signal of the Q component of the X-polarized component from the first optical hybrid circuit 115A and adjusts the gain and then outputs an electric signal after the adjustment of the gain to the second output port 117B.

The third PD 116C electrically converts the light signal of the I component of the Y-polarized component from the second optical hybrid circuit 115B and adjusts the gain and then outputs an electric signal after the adjustment of the gain to the third output port 117C. The fourth PD 116D electrically converts the light signal of the Q component of the Y-polarized component from the second optical hybrid circuit 115B and adjusts the gain and then outputs an electric signal after the adjustment of the gain to the fourth output port 117D.

FIG. 12 is a plane schematic view illustrating an example of an EC portion in the light chip 100. The EC portion illustrated in FIG. 12 is a portion of a board-type optical waveguide device that is optically coupled with a core C of the optical fiber. The EC portion includes the first EC 111 of the signal light port and the second EC 112 of the local oscillation light port. The received light contains TE light and TM light and thus the first EC 111 directs the TE light and the TM light. The local oscillation light is TE light and thus the second EC 112 directs the TE light. Note that the second EC 112 has the same configuration as that of the first EC 111 and the same reference numerals are assigned and thus description of the redundant configuration and operations will be omitted.

The first EC 111 includes a cladding 121 formed of SiO₂, or the like, and a first waveguide 122 that is covered with the cladding 121 and that is formed of, for example, Si₃N₄ (simply referred to as SiN (Silicon Nitride) below). The first EC 111 includes a second waveguide 123 that is covered with the cladding 121 and that is formed of, for example, Si, or the like, and a heat insulating conversion portion 124 in which light optically transitions in a heat-insulating manner between the first waveguide 122 and the second waveguide 123. Furthermore, the first EC 111 has an inversely taper portion 125 having a structure in which a waveguide width to the chip end face D11 of the first waveguide 122 decreases gradually.

The first waveguide 122 includes a first taper waveguide 122A and a second taper waveguide 122B that connects to the first taper waveguide 122A. The first taper waveguide 122A has a structure in which the waveguide width increases gradually from a light input-output portion near the chip end face D11 to a start point. The second taper waveguide 122B has a structure in which a portion connected to the start point of the first taper waveguide 122A serves as a start point and the waveguide width decreases gradually as it separates from the start point of the first taper waveguide 122A.

The second waveguide 123 includes a third taper waveguide 123A that is arranged in a position such that at least part of the third taper waveguide 123A overlaps the second taper waveguide 122B in a plane direction and a liner waveguide 123B that connects to the third taper waveguide 123A. The third taper waveguide 123A has a structure in which the waveguide width increases gradually as it separates from the start point of the second taper waveguide 122B. The liner waveguide 123B is a waveguide that connects to a side on which the waveguide width of the third taper waveguide 123A is wide.

FIG. 13A is an illustration illustrating an example of a schematic cross-sectional part of the first EC 111 taken along the line A-A illustrated in FIG. 12. The first EC 111 illustrated in FIG. 13A includes a Si substrate 131, the cladding 121, a first assembly layer 141A that is arranged on a side distant from the Si substrate 131, and a second assembly layer 141B that is arranged on a side close to the Si substrate 131. The cross-sectional part taken along the line A-A illustrated in FIG. 13A is a cross-sectional portion of the first EC 111 in which the liner waveguide 123B is arranged. The liner waveguide 123B in the second waveguide 123 is arranged in the second assembly layer 141B.

FIG. 13B is an illustration illustrating an example of a schematic cross-sectional part of the first EC 111 taken along the line B-B illustrated in FIG. 12. The first EC 111 illustrated in FIG. 13B includes the Si substrate 131, the cladding 121, the first assembly layer 141A, and the second assembly layer 141B. The schematic cross-sectional part taken along the line B-B illustrated in FIG. 13B is a cross-sectional portion of the first EC 111 in which the heat insulating conversion portion 124 is arranged. The third taper waveguide 123A in the second waveguide 123 is arranged in the second assembly layer 141B. The second taper waveguide 122B in the first waveguide 122 is arranged in the first assembly layer 141A.

FIG. 13C is an illustration illustrating an example of a schematic cross-sectional part of the first EC 111 taken along the line C-C illustrated in FIG. 12. The first EC 111 illustrated in FIG. 13C includes the Si substrate 131 and the cladding 121 that is layered on the Si substrate 131. The schematic cross-sectional part taken along the line C-C illustrated in FIG. 13C is a cross-sectional portion of the first EC 111 in which the inversely taper portion 125 is arranged. Furthermore, the first EC 111 includes the first assembly layer 141A and the second assembly layer 141B. The first taper waveguide 122A in the first waveguide 122 is arranged in the first assembly layer 141A.

The configuration of the heat insulating conversion portion 124 and the inversely taper portion 125 of the first EC 111 is the same as the heat insulating conversion portion 124 and the inversely taper portion 125 of the second EC 112 and have the same waveguide width, waveguide length, and waveguide thickness.

The first EC 111 illustrated in FIG. 12 directs the received light from the first optical fiber F11 to the heat insulating conversion portion 124 using the inversely taper portion 125. In the heat insulating conversion portion 124, the waveguide widths of the first waveguide 122 and the second waveguide 123 change to taper forms. The first waveguide 122 has a refractive index lower than that of the second waveguide 123 and thus it is possible to increase the mode field of the received light and reduce the loss of coupling with the first optical fiber F11.

The second EC 112 directs the local oscillation light from the second optical fiber F12 to the heat insulating conversion portion 124 using the inversely taper portion 125. In the heat insulating conversion portion 124, the waveguide widths of the first waveguide 122 and the second waveguide 123 change to taper forms. The first waveguide 122 has a refractive index lower than that of the second waveguide 123 and thus it is possible to increase the mode field of the local oscillation light and reduce the loss of coupling with the second optical fiber F12.
Patent Literature 1: U.S. Patent Application Publication No. 2005/0185893
Patent Literature 2: U.S. Patent Application Publication No. 2018/0321445
Patent Literature 3: Japanese National Publication of International Patent Application No. 2008-530615
Patent Literature 4: Japanese National Publication of International Patent Application No. 2006-517673

In the ECs, however, it is needed that the waveguide has an appropriate waveguide width on the chip end face D11 in order to reduce the loss in coupling with the optical fiber. When the waveguide width of the inversely taper portion 125 increases in a taper form from the chip end face D11 in FIG. 12, because of a deviation from a tolerance from a dicing line DL at the time when a wafer is diced or polished, the waveguide width of the first waveguide 122 on the chip end face D11 varies from a design value. As a result, in the EC, the loss in coupling with the optical fiber increases due to the deviation from the tolerance caused in dicing or polishing.

When the position of dicing shifts in the left direction in the drawing because of the deviation from the tolerance from the dicing line DL in FIG. 12 and the waveguide length of the inversely taper portion 125 of the second EC 112 decreases, the waveguide width of the inversely taper portion 125 on the side of the chip end face D11 increases. As a result, the loss in coupling with the core C of the second optical fiber F12 increases and the loss of the TE light directed in the second EC 112 increases. Particularly, the local oscillation light that is directed in the second EC 112 of the local oscillation light port is TE light and thus the loss of the TE light is noticeable compared to the first EC 111.

### SUMMARY

According to an aspect of an embodiment, an optical device includes a first edge coupler, a second edge coupler, a first taper portion and a second taper portion. The first edge coupler is connected to a polarization multiplexer-demultiplexer and makes contact with an end face. The second edge coupler is connected to an optical hybrid circuit and makes contact with the end face. The first taper portion directs light from the end face and is contained in the first edge coupler. The second taper portion directs light from the end face and is contained in the second edge coupler. The second taper portion has a structure in which a taper angle of the second taper portion with respect to the end face is smaller than a taper angle of the first taper portion with respect to the end face.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an illustration illustrating an example of a light chip of the present example;

FIG. 2 is a plane schematic view illustrating an example of an EC portion in a light chip of Example 1;

FIG. 3A is an illustration illustrating an example of a schematic cross-sectional part of a second EC taken along the line A-A illustrated in FIG. 2;

FIG. 3B is an illustration illustrating an example of a schematic cross-sectional part of the second EC taken along the line B-B illustrated in FIG. 2;

FIG. 3C is an illustration illustrating an example of a schematic cross-sectional part of the second EC taken along the line C-C illustrated in FIG. 2;

FIG. 4A is an illustration illustrating an example of a relationship between a dicing position and a light loss with respect to each taper length of a second inversely taper portion;

FIG. 4B is an illustration illustrating an example of a relationship between a dicing position and a light loss with respect to each taper length of a first inversely taper portion;

FIG. 5 is a plane schematic view illustrating an example of an EC portion in a light chip of Example 2;

FIG. 6 is a plane schematic view illustrating an example of an EC portion in a light chip of Example 3;

FIG. 7 is a plane schematic view illustrating an example of an EC portion in a light chip of Example 4;

FIG. 8A is an illustration illustrating an example of a schematic cross-sectional part of a second EC taken along the line A-A illustrated in FIG. 7;

FIG. 8B is an illustration illustrating an example of a schematic cross-sectional part of the second EC taken along the line B-B illustrated in FIG. 7;

FIG. 8C is an illustration illustrating an example of a schematic cross-sectional part of the second EC taken along the line C-C illustrated in FIG. 7;

FIG. 9 is a plane schematic view illustrating an example of an EC portion in a light chip of Example 5;

FIG. 10 is an illustration illustrating an example of an optical transceiver of the present example;

FIG. 11 is an illustration illustrating an example of a conventional light chip;

FIG. 12 is a plane schematic view illustrating an example of an EC portion in a light chip;

FIG. 13A is an illustration illustrating an example of a schematic cross-sectional part of a first EC taken along the line A-A illustrated in FIG. 12;

FIG. 13B is an illustration illustrating an example of a schematic cross-sectional part of the first EC taken along the line B-B illustrated in FIG. 12; and

FIG. 13C is an illustration illustrating an example of a schematic cross-sectional part of the first EC taken along the line C-C illustrated in FIG. 12.

### DESCRIPTION OF EMBODIMENTS

Preferred embodiments of the present invention will be explained with reference to accompanying drawings. Note that the embodiment does not limit the disclosure. Note that the examples illustrated below may be combined as appropriate within a range such that no inconsistency is caused.

### (a) Example 1

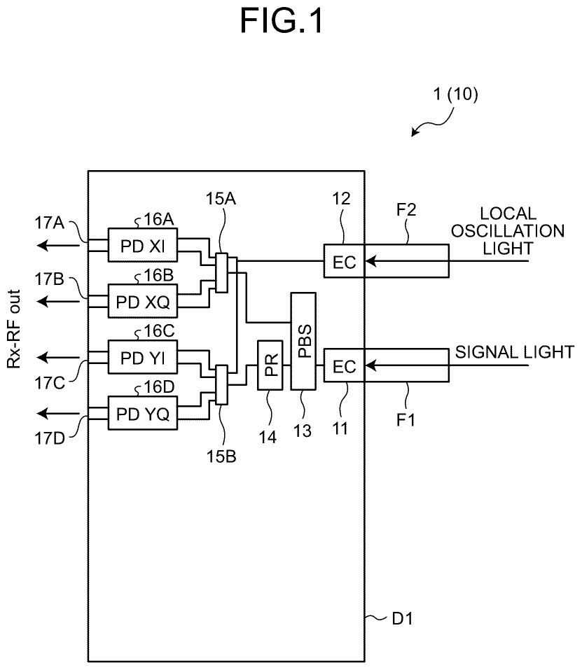

FIG. 1 is an illustration illustrating an example of a light chip 1 of the present example. The light chip 1 illustrated in FIG. 1 is, for example, a light IC chip including an optical receiver 10 of a digital coherent function. The optical receiver 10 includes a first edge coupler (EC) 11 that is arranged in a signal light port to which signal light is input, a second EC 12 that is arranged in a local oscillation light port to which local oscillation light is input, a polarization beam splitter (PBS) 13, and a polarization rotator (PR) 14. The optical receiver 10 includes a first optical hybrid circuit 15A, a second optical hybrid circuit 15B, first to fourth photo diodes (PDs) 16A to 16D, and first to fourth output ports 17A to 17D. For example, the second EC 12 and the first optical hybrid circuit 15A, the second EC 12 and the second optical hybrid circuit 15B, the first EC 11 and the PBS 13 are connected with optical waveguides, such as Si waveguides.

The first EC 11 of the signal light port is formed on a chip end face D1 that is a side surface end in the light chip 1 and is, for example, an EC of the port that connects to the first optical fiber F1 to which received light that is a light signal is input. Note that the signal light port is exposed on the chip end face D1 of the light chip 1 by forming a wafer into a chip. The second EC 112 of the local oscillation light port is formed on the chip end face D11 of the light chip 100 and is, for example, an EC of the port that connects to the second optical fiber F2 to which local oscillation light from a light source is input. Note that the local oscillation light port is exposed on the chip end face D1 of the light chip 1 by forming a wafer into a chip.

The PBS 13 is a polarization multiplexer-demultiplexer that separates the received light that is input from the first EC 11 into two intersecting polarized states, for example, received light of a X-polarized wave component that is a transverse electric (TE) polarized wave and a Y-polarized wave component that is a transverse magnetic (TM) polarized wave. The PBS 13 outputs the received light of the X-polarized wave component from the received light to the first optical hybrid circuit 15A. Furthermore, the PR 14 makes a polarized wave rotation on the received light of the Y-polarized wave component from the PBS 13 by 90 degrees, to convert the received light into received light of the Y-polarized wave component after the polarized wave rotation and outputs the received light to the second optical hybrid circuit 15B.

The first optical hybrid circuit 15A interferes the received light of the X-polarized component with the local oscillation light and acquires light signals of an I component and a Q component. Note that the I component is an in-phase component and the Q component is a quadrature phase component. The first optical hybrid circuit 15A outputs the light signal of the I component in the received light of the X-polarized component to the first PD 16A. The first optical hybrid circuit 15A outputs the light signal of the Q component in the received light of the X-polarized component to the second PD 16B.

The second optical hybrid circuit 15B interferes the received light of the Y-polarized component with the local oscillation light and acquires light signals of an I component and a Q component. The second optical hybrid circuit 15B outputs the light signal of the I component in the received light of the Y-polarized component to the third PD 16C. The second optical hybrid circuit 15B outputs the light signal of the Q component in the received light of the Y-polarized component to the fourth PD 16D.

The first PD 16A electrically converts the light signal of the I component of the X-polarized component from the first optical hybrid circuit 15A and adjusts the gain and then outputs an electric signal after the adjustment of the gain to the first output port 17A. The second PD 16B electrically converts the light signal of the Q component of the X-polarized component from the first optical hybrid circuit 15A and adjusts the gain and then outputs an electric signal after the adjustment of the gain to the second output port 17B.

The third PD 16C electrically converts the light signal of the I component of the Y-polarized component from the second optical hybrid circuit 15B and adjusts the gain and then outputs an electric signal after the adjustment of the gain to the third output port 17C. The fourth PD 16D electrically converts the light signal of the Q component of the Y-polarized component from the second optical hybrid circuit 15B and adjusts the gain and then outputs an electric signal after the adjustment of the gain to the fourth output port 17D.

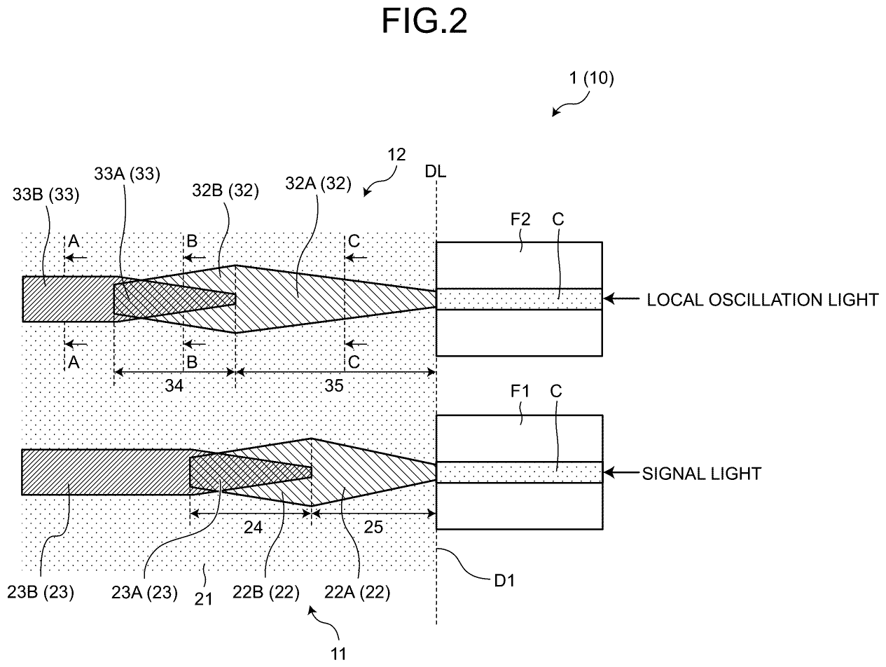

FIG. 2 is a plane schematic view illustrating an example of an EC portion in the light chip 1. The EC portion illustrated in FIG. 2 is an EC of a board-type optical waveguide device that is optically coupled with a core C of the optical fiber. The EC portion includes the first EC 11 of the signal light port and the second EC 12 of the local oscillation light port. The received light contains TE light and TM light and thus the first EC 11 directs the TE light and the TM light. The local oscillation light is TE light and thus the second EC 12 directs the TE light.

The first EC 11 includes a cladding 21 formed of SiO₂, or the like, and a first waveguide 22 that is covered with the cladding 21 and that is formed of, for example, Si₃N₄ (simply referred to as SiN (Silicon Nitride) below), or the like. The first EC 11 includes a second waveguide 23 that is covered with the cladding 21 and that is formed of, for example, Si, or the like, and a first heat insulating conversion portion 24 in which light optically transitions in a heat-insulating manner between the first waveguide 22 and the second waveguide 23. Furthermore, the first EC 11 has a first inversely taper portion 25 having a structure in which a waveguide width to the chip end face D1 of the first waveguide 22 decreases gradually. The first inversely taper portion 25 is a first taper portion that is contained in the first EC 11 and that directs the received light from the first optical fiber F1 that connects to the chip end face D1.

The first waveguide 22 includes a first taper waveguide 22A and a second taper waveguide 22B that connects to the first taper waveguide 22A. The first taper waveguide 22A has a structure in which the waveguide width increases gradually from a light input-output portion near the chip end face D1 to a start point. The second taper waveguide 122B has a structure in which a portion connecting to the start point of the first taper waveguide 22A serves as a start point and the waveguide width decreases gradually as it separates from the start point of the first taper waveguide 22A.

The second waveguide 23 includes a third taper waveguide 23A that is arranged in a position such that at least part of the third taper waveguide 23A overlaps the second taper waveguide 22B in a plane direction and a liner waveguide 23B that connects to the third taper waveguide 23A. The third taper waveguide 23A has a structure in which the waveguide width increases gradually as it separates from the start point of the second taper waveguide 22B. The liner waveguide 23B is a waveguide that connects to a side on which the waveguide width of the third taper waveguide 23A is wide.

The second EC 12 includes the cladding 21 formed of SiO₂, or the like, and a third waveguide 32 that is covered with the cladding 21 and that is formed of, for example, SiN, or the like. The second EC 12 includes a fourth waveguide 33 that is covered with the cladding 21 and that is formed of, for example, Si, or the like, and a second heat insulating conversion portion 34 in which light optically transitions in a heat-insulating manner between the third waveguide 32 and the fourth waveguide 33. Furthermore, the second EC 12 has a second inversely taper portion 35 having a structure in which a waveguide width to the chip end face D1 of the third waveguide 32 decreases gradually. The second inversely taper portion 35 is a second taper portion that is contained in the second EC 12 and that directs the local oscillation light from the second optical fiber F2 that connects to the chip end face D1.

The third waveguide 32 includes a fourth taper waveguide 32A and a fifth taper waveguide 32B that connects to the fourth taper waveguide 32A. The fourth taper waveguide 32A has a structure in which the waveguide width increases gradually from a light input-output portion near the chip end face D1 to a start point. The fifth taper waveguide 32B has a structure in which a portion connecting to the start point of the fourth taper waveguide 32A serves as a start point and the waveguide width decreases gradually as it separates from the start point of the fourth taper waveguide 32A.

The fourth waveguide 33 includes a sixth taper waveguide 33A that is arranged in a position such that at least part of the sixth taper waveguide 33A overlaps the fifth taper waveguide 32B in a plane direction and a liner waveguide 33B that connects to the sixth taper waveguide 33A. The sixth taper waveguide 33A has a structure in which the waveguide width increases gradually as it separates from the start point of the fifth taper waveguide 32B. The liner waveguide 33B is a waveguide that connects to a side on which the waveguide width of the sixth taper waveguide 33A is wide.

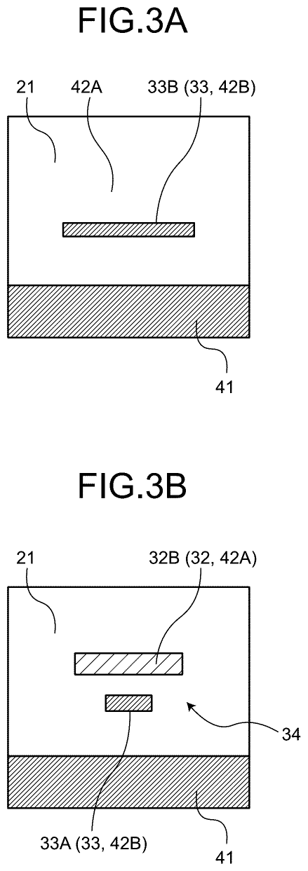

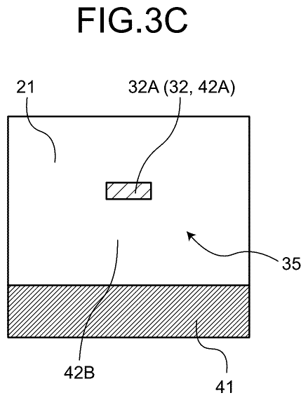

FIG. 3A is an illustration illustrating an example of a schematic cross-sectional part of the second EC 12 taken along the line A-A illustrated in FIG. 2. The second EC 12 illustrated in FIG. 3A includes a Si substrate 41, the cladding 121, a first assembly layer 42A that is arranged on a side distant from the Si substrate 41, and a second assembly layer 42B that is arranged on a side close to the Si substrate 41. The cross-sectional part taken along the line A-A illustrated in FIG. 3A is a cross-sectional portion of the second EC 12 in which the liner waveguide 33B is arranged. The liner waveguide 33B in the fourth waveguide 33 is arranged in the second assembly layer 42B.

FIG. 3B is an illustration illustrating an example of a schematic cross-sectional part of the second EC 12 taken along the line B-B illustrated in FIG. 2. The second EC 12 illustrated in FIG. 3B includes the Si substrate 41, the cladding 21, the first assembly layer 42A, and the second assembly layer 42B. The schematic cross-sectional part taken along the line B-B illustrated in FIG. 3B is a cross-sectional portion of the second EC 12 in which the second heat insulating conversion portion 34 is arranged. The sixth taper waveguide 33A in the fourth waveguide 33 is arranged in the second assembly layer 42B. The fifth taper waveguide 32B in the third waveguide 32 is arranged in the first assembly layer 42A.

FIG. 3C is an illustration illustrating an example of a schematic cross-sectional part of the second EC 12 taken along the line C-C illustrated in FIG. 2. The second EC 12 illustrated in FIG. 3C includes the Si substrate 41 and the cladding 121 that is layered on the Si substrate 41. The schematic cross-sectional part taken along the line C-C illustrated in FIG. 3C is a cross-sectional portion of the second EC 12 in which the second inversely taper portion 35 is arranged. Furthermore, the second EC 12 includes the first assembly layer 42A and the second assembly layer 42B. The fourth taper waveguide 32A in the third waveguide 32 is arranged in the first assembly layer 42A.

The size of a waveguide length of the second heat insulating conversion portion 34 of the second EC 12 that directs only TE light is equal to the size of the waveguide length of the first heat insulating conversion portion 24 of the first EC 11 that directs TE light and TM light. The taper angle of the second inversely taper portion 35 of the second EC 12 with respect to the chip end face D1 however is smaller than the taper angle of the first inversely taper portion 25 of the first EC 11 with respect to the chip end face D1. The waveguide length (taper length) of the second inversely taper portion 35 is longer than the waveguide length (taper length) of the first inversely taper portion 25. The waveguide width of the second inversely taper portion 35 on the side of the chip end face D1 is narrower than the waveguide width of the first inversely taper portion 25 on the side of the chip end face D1.

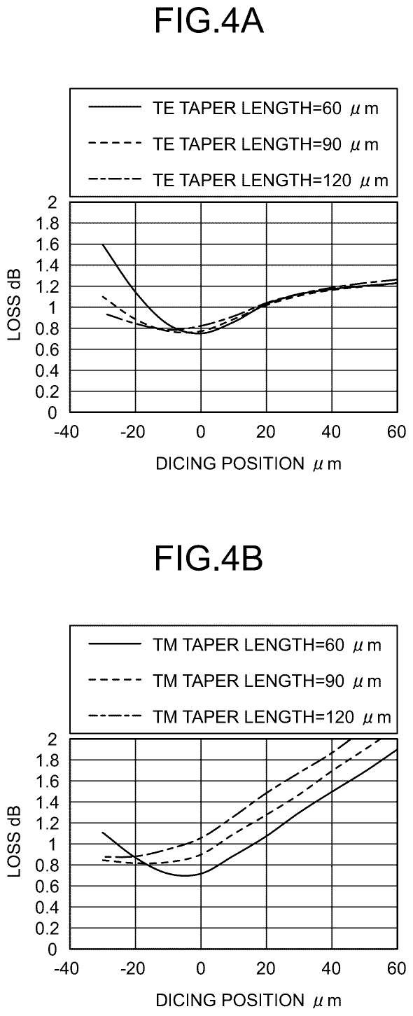

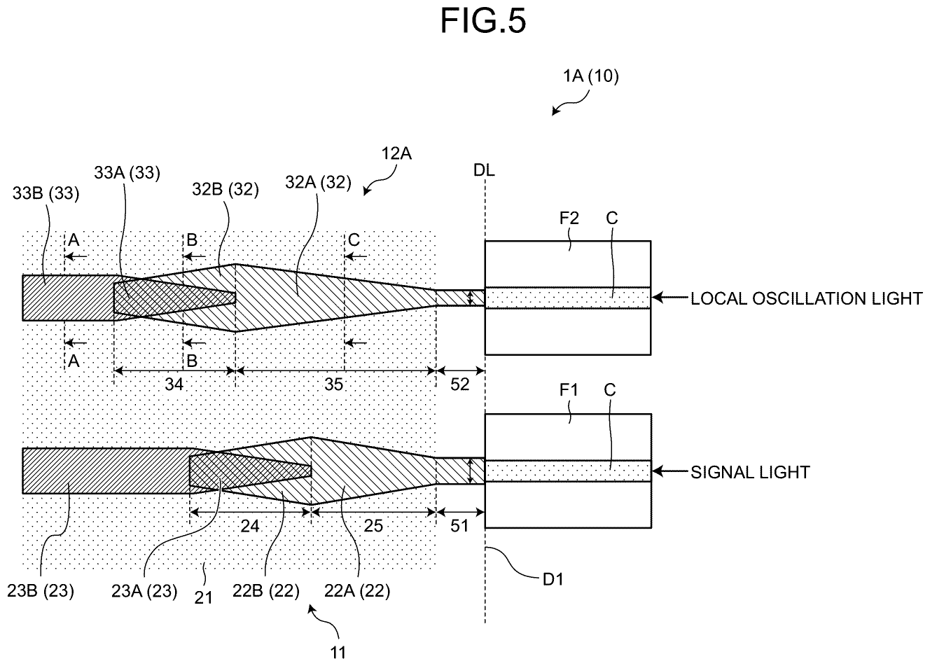

FIG. 4A is an illustration illustrating an example of a relationship between a dicing position and a light loss with respect to each taper length of the second inversely taper portion 35. When the dicing position between the wafer and the light chip 1 is 0 (no shift), the loss of TE light is 0.8 dB and, when the dicing position shifts to the left by 20 μm in FIG. 2 and accordingly the taper length of the second inversely taper portion 35 decreases to 60 μm, the loss of TE light increases to 1.2 dB. On the other hand, when the dicing position shifts to the right in FIG. 2 and accordingly the taper length of the second inversely taper portion 35 increases to 120 μm, the loss of TE light increases slightly.

FIG. 4B is an illustration illustrating an example of a relationship between a dicing position and a light loss with respect to each taper length of the first inversely taper portion 25. When the dicing position between a wafer and the light chip 1 shifts to the right in FIG. 2 and accordingly the taper length of the first inversely taper portion 25 increases to 120 μm, the loss of TM light increases to 1.5 dB. On the other hand, when the dicing position shifts to the left in FIG. 2 and accordingly the taper length of the first inversely taper portion 25 decreases to 60 μm, it is possible to inhibit the loss of TM light at 1.1 dB. Accordingly, the taper length of the second inversely taper portion 35 is at 120 μm and the taper length of the first inversely taper portion 25 is at 60 μm shorter than the taper length of the second inversely taper portion 35 and thus it is possible to inhibit the light loss due to a dicing shift from increasing.

The first EC 11 illustrated in FIG. 2 directs the received light from the first optical fiber F1 to the first heat insulating conversion portion 24 using the first inversely taper portion 25. In the first heat insulating conversion portion 24, the waveguide widths of the first waveguide 22 and the second waveguide 23 change to taper forms. The first waveguide 22 has a refractive index lower than that of the second waveguide 23 and thus it is possible to increase the mode field of the received light and reduce the loss of coupling with the first optical fiber F1.

The second EC 12 directs the local oscillation light from the second optical fiber F2 to the second heat insulating conversion portion 34 using the second inversely taper portion 35. In the second heat insulating conversion portion 34, the waveguide widths of the third waveguide 32 and the fourth waveguide 33 change to taper forms. The third waveguide 32 has a refractive index lower than that of the fourth waveguide 33 and thus it is possible to increase the mode field of the local oscillation light and reduce the loss of coupling with the second optical fiber F2.

The taper angle of the second inversely taper portion 35 of the second EC 12 with respect to the chip end face D1 is smaller than the taper angle of the first inversely taper portion 25 of the first EC 11 with respect to the chip end face D1. The waveguide length (taper length) of the second inversely taper portion 35 is longer than the waveguide length (taper length) of the first inversely taper portion 25. The waveguide width of the second inversely taper portion 35 on the side of the chip end face D1 is narrower than the waveguide width of the first inversely taper portion 25 on the side of the chip end face D1. As a result, it is possible to reduce the loss of coupling between the second EC 12 and the second optical fiber F2 due to a deviation from a tolerance in dicing and realize an EC highly tolerant to the deviation from the tolerance in dicing.

Note the case where the taper angle of the second inversely taper portion 35 of the Example 1 with respect to the chip end face D1 is smaller than the taper angle of the first inversely taper portion 25 with respect to the chip end face D1 and the taper length of the second inversely taper portion 35 is longer than the taper length of the first inversely taper portion 25 has been exemplified. The same effect however is obtained by, regardless of the taper length of the second inversely taper portion 35, only setting the taper angle of the second inversely taper portion 35 with respect to the chip end face D1 smaller than the taper angle of the first inversely taper portion 25 with respect to the chip end face D1. Also in this case, because the waveguide width of the second inversely taper portion 35 on the side of the chip end face D1 is narrower than the waveguide width of the first inversely taper portion 25 on the side of the end face D1, the loss in coupling with the core C of the second optical fiber F2 decreases and accordingly it is possible to reduce the loss of TE light that is directed in the second EC 12. Accordingly, it is possible to reduce the loss of coupling between the second EC 12 and the second optical fiber F2 due to a deviation from a tolerance in dicing and realize an EC highly tolerant to the deviation from the tolerance in dicing.

When the position of dicing shifts in the right direction in FIG. 2 because of the deviation from the tolerance from the dicing line DL and thus the waveguide length of the first inversely taper portion 25 of the first EC 11 increases, the part in which the waveguide width of the first inversely taper portion 25 on the side of the chip end face D1 continues long. Confinement of TM light that is guided in the first EC 11 is lower than that of TE light and the part in which the waveguide width of the first inversely taper portion 25 on the side of the chip end face D1 continues long and therefore the loss of TM light increases. An embodiment in which such a situation is dealt with will be described as Example 2 below.

### (b) Example 2

FIG. 5 is a plane schematic view illustrating an example of an EC portion in a light chip 1A of Example 2. Note that the same reference numerals are assigned to the same configuration as that of the light chip 1 of Example 1 and thus description of the redundant configuration and operations will be omitted. The light chip 1A is different from the light chip 1 of Example 1 in that the end point of the second inversely taper portion 35 is not the chip end face D1 and a second excess portion 52 is arranged between the end point of the second inversely taper portion 35 and the chip end face D1. A further different point is in that the end point of the first inversely taper portion 25 is not the chip end face D1 and a first excess portion 51 is arranged between the end point of the first inversely taper portion 25 and the chip end face D1.

The first excess portion 51 is a liner waveguide that optically couples the first inversely taper portion 25 and the core C of the first optical fiber F1 and that directs received light from the core C of the first optical fiber F1 and is part of the first waveguide 22. The waveguide width of the first excess portion 51 is equal to the waveguide width of the first inversely taper portion 25 on the side of the end point. Even when the dicing position shifts, the first excess portion 51 allows the shift of the dicing position within the range of the waveguide length of the first excess portion 51. When the shift of dicing is within the first excess portion 51, the shift has no effect on the waveguide width in the end point of the first inversely taper portion 25.

The second excess portion 52 is a liner waveguide that optically couples the second inversely taper portion 35 and the core C of the second optical fiber F2 and that directs local oscillation light from the core C of the second optical fiber F2 and is part of the third waveguide 22. The waveguide width of the second excess portion 52 is equal to the waveguide width of the second inversely taper portion 35 on the side of the end point. Even when the dicing position shifts, the second excess portion 52 allows the shift of the dicing position within the range of the waveguide length of the second excess portion 52. When the shift of dicing is within the second excess portion 52, the shift has no effect on the waveguide width in the end point of the second inversely taper portion 35. The waveguide length of the first excess portion 51 is equal to the waveguide length of the second excess portion 52.

The first EC 11 illustrated in FIG. 5 directs the received light from the first optical fiber F1 to the first inversely taper portion 25 using the first excess portion 51 and directs the received light to the first heat insulating conversion portion 24 using the first inversely taper portion 25. In the first heat insulating conversion portion 24, the waveguide widths of the first waveguide 22 and the second waveguide 23 change to taper forms. The first waveguide 22 has a refractive index lower than that of the second waveguide 23 and thus it is possible to increase the mode field of the received light and reduce the loss of coupling with the first optical fiber F1.

A second EC 12A directs the local oscillation light from the second optical fiber F2 to the second inversely taper portion 35 using the second excess portion 52 and directs the local oscillation light from the second optical fiber F2 using the second inversely taper portion 35. In the second heat insulating conversion portion 34, the waveguide widths of the third waveguide 32 and the fourth waveguide 33 change to taper forms. The third waveguide 32 has a refractive index lower than that of the fourth waveguide 33 and thus it is possible to increase the mode field of the local oscillation light and reduce the loss of coupling with the second optical fiber F2.

The taper angle of the second inversely taper portion 35 of the second EC 12 with respect to the chip end face D1 is smaller than the taper angle of the first inversely taper portion 25 of the first EC 11 with respect to the chip end face D1. The waveguide length (taper length) of the second inversely taper portion 35 is longer than the waveguide length (taper length) of the first inversely taper portion 25. As a result, the waveguide width of the second inversely taper portion 35 on the side of the chip end face D1 is narrower than the waveguide width of the first inversely taper portion 25 on the side of the chip end face D1 and accordingly the loss of coupling with the core C of the second optical fiber F2 decreases, which makes it possible to reduce the loss of TE light that is directed in a second EC 11A.

Furthermore, the waveguide width of the second excess portion 52 is equal to the waveguide width of the second inversely taper portion 35 on the side of the chip end face D1 and the waveguide width of the first excess portion 51 is equal to the waveguide width of the first inversely taper portion 25 on the side of the chip end face D1. As a result, even when a shift of the dicing position occurs within the range of the waveguide lengths of the first excess portion 51 and the second excess portion 52, the waveguide width of the first inversely taper portion 25 on the side of the chip end face D1 and the waveguide width of the second inversely taper portion 35 on the side of the chip end face D1 prevents a change due to the shift of the position of dicing. As a result, it is possible to reduce the loss of coupling between the second EC 11A and the second optical fiber F2 due to a deviation from a tolerance in dicing and realize an EC highly tolerant to the deviation from the tolerance in dicing.

The case where, as for the second excess portion 52 of Example 2, the waveguide width of the second inversely taper portion 35 on the side of the chip end face D1 is narrow than the waveguide width of the first inversely taper portion 25 on the side of the chip end face D1 has been exemplified. The waveguide width of the second inversely taper portion 35 on the side of the chip end face D1 however may be equal to the waveguide width of the first inversely taper portion 25 and is changeable as appropriate.

Note that, as for the light chip 1A of Example 2, the case where the dicing position shifts and the waveguide lengths of the first excess portion 51 and the second excess portion 52 decrease has been exemplified, and the case where the dicing position shifts and the waveguide lengths of the first excess portion 51 and the second excess portion 52 increase is assumable. When the dicing position shifts and the waveguide lengths of the first excess portion 51 and the second excess portion 52 increase, the loss of light in the first excess portion 51 that directs TM light increases. This is because the wavelength width of the first excess portion 51 is narrower than the waveguide width of the first inversely taper portion 25, confinement of light is low, and the propagation loss of TM light increase.

An embodiment in which such a situation is dealt with will be described as Example 3 below.

### (c) Example 3

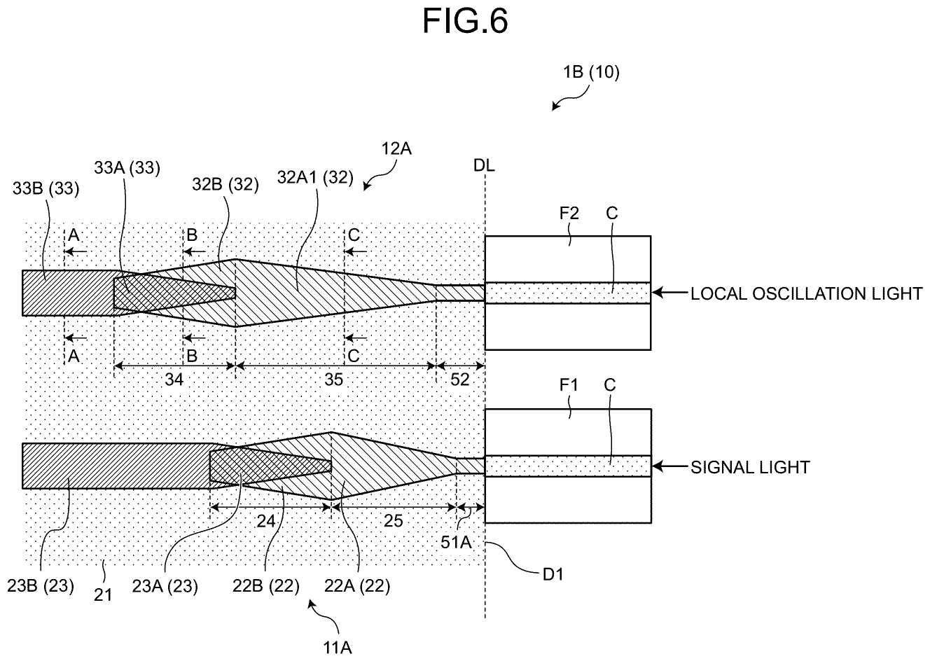

FIG. 6 is a plane schematic view illustrating an example of an EC portion in a light chip 1B of Example 3. Note that the same reference numerals are assigned to the same configuration as that of the light chip 1A of Example 2 and thus description of the redundant configuration and operations will be omitted. The light chip 1B of Example 3 is different from the light chip 1A of Example 2 in that the waveguide length of a first excess portion 51A is shorter than a waveguide length of the second excess portion 52.

In the light chip 1B of Example 3, even when a dicing position shifts to the side of a wafer and the waveguide lengths of the first excess portion 51A and the second excess portion 52 increase, the waveguide length of the first excess portion 51A that directs TM light can be shorter than the waveguide length of the second excess portion 52. As a result, it is possible to inhibit a loss of TM light in the first excess portion 51A that directs TM light.

As for the light chip 1 of Example 1, the case where the taper length of the second inversely taper portion 35 is longer than the taper length of the first inversely taper portion 25 is exemplified; however, the light chip is not limited to this and the embodiment thereof will be described as Example 4 below.

### (d) Example 4

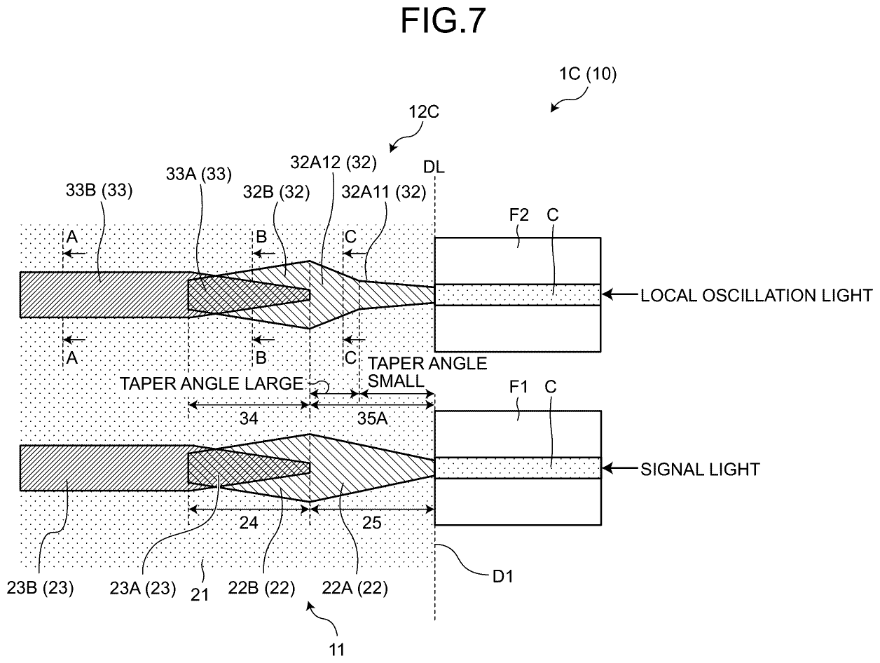

FIG. 7 is a plane schematic view illustrating an example of an EC portion in a light chip 1C of Example 4. Note that the same reference numerals are assigned to the same configuration as that of the light chip 1 of Example 1 and thus description of the redundant configuration and operations will be omitted. The light chip 1C of Example 4 is different from the light chip 1 of Example 1 in including, instead of the second inversely taper portion 35, a third inversely taper portion 35A including an eighth taper waveguide 32A11 and a ninth taper waveguide 32A12 that have different taper angles.

The third inversely taper portion 35A includes the eighth taper waveguide 32A11 and the ninth taper waveguide 32A12 that connects to the eighth taper waveguide 32A11. The eighth taper waveguide 32A11 has a structure in which the waveguide width increases gradually from the chip end face D1 toward a start point of the eighth taper waveguide 32A11. The ninth taper waveguide 32A12 has a structure in which a portion connecting to the start point of the eighth taper waveguide 32A11 serves as a start point of the ninth taper waveguide 32A12 and the waveguide width decreases gradually as it separates from the start point of the eighth taper waveguide 32A11. In the ninth taper waveguide 32A12, the end point of the ninth taper waveguide 32A12 connects to the fifth taper waveguide 32B in the second heat insulating conversion portion 34. The taper angle of the eighth taper waveguide 32A11 with respect to the chip end face D1 is smaller than the taper angle of the ninth taper waveguide 32A12 with respect to the chip end face D1 in the start point of the eighth taper waveguide 32A11. As a result, the taper length (waveguide length) of the third inversely taper portion 35A can be shorter than the taper length (waveguide length) of the second inversely taper portion 35 illustrated in FIG. 2.

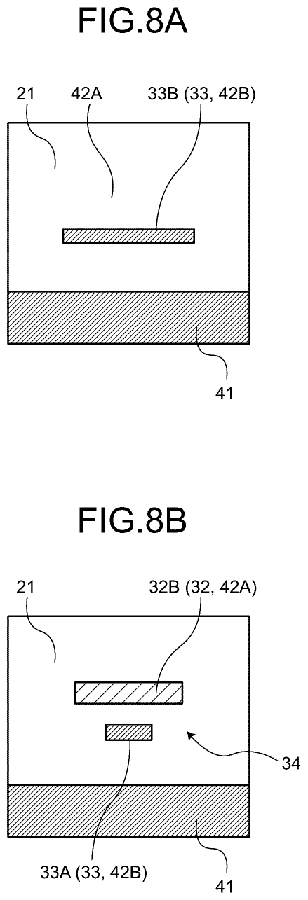

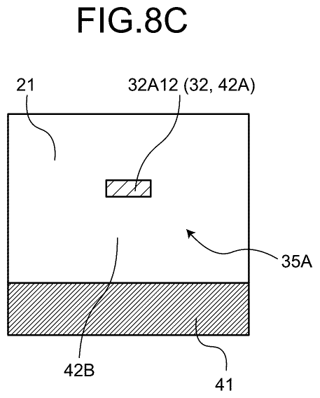

FIG. 8A is an illustration illustrating an example of a schematic cross-sectional part of a second EC 12C taken along the line A-A illustrated in FIG. 7. The second EC 12C illustrated in FIG. 8A includes the Si substrate 41, the cladding 21, the first assembly layer 42A, and the second assembly layer 42B. The cross-sectional part taken along the line A-A illustrated in FIG. 8A is a cross-sectional portion of the second EC 12C in which the liner waveguide 33B is arranged. The liner waveguide 33B in the fourth waveguide 33 is arranged in the second assembly layer 42B.

FIG. 8B is an illustration illustrating an example of a schematic cross-sectional part of the second EC 12C taken along the line B-B illustrated in FIG. 7. The second EC 12C illustrated in FIG. 8B includes the Si substrate 41, the cladding 21, the first assembly layer 42A, and the second assembly layer 42B. The schematic cross-sectional part taken along the line B-B illustrated in FIG. 8B is a cross-sectional portion of the second EC 12C in which the second heat insulating conversion portion 34 is arranged. The sixth taper waveguide 33A in the fourth waveguide 33 is arranged in the second assembly layer 42B. The fifth taper waveguide 32B in the third waveguide 32 is arranged in the first assembly layer 42A.

FIG. 8C is an illustration illustrating an example of a schematic cross-sectional part of the second EC 12C taken along the line C-C illustrated in FIG. 7. The second EC 12 illustrated in FIG. 8C includes the Si substrate 41 and the cladding 21 that is layered on the Si substrate 41. The schematic cross-sectional part taken along the line C-C illustrated in FIG. 8C is a cross-sectional portion of the second EC 12C in which the third inversely taper portion 35A is arranged. Furthermore, the second EC 12C includes the first assembly layer 42A and the second assembly layer 42B. The ninth taper waveguide 32A12 in the third waveguide 32 is arranged in the first assembly layer 42A.

The waveguide length of the second heat insulating conversion portion 34 that directs only TE light is equal to the waveguide length of the first heat insulating conversion portion 24 that direct TE light and TM light. The waveguide width of the third inversely taper portion 35A in the start point however is equal to the waveguide width of the third inversely taper portion 35A in the start point. Furthermore, the taper angle of the third inversely taper portion 35A with respect to the chip end face D1 is smaller than the taper angle of the first inversely taper portion 25 with respect to the chip end face D1. As a result, even when the taper length of the third inversely taper portion 35A is kept equal to the taper length of the first inversely taper portion 25, the waveguide width of the third inversely taper portion 35A on the side of the chip end face D1 is narrower than the waveguide width of the first inversely taper portion 25 on the side of the chip end face D1. As a result, the loss in coupling with the core C of the second optical fiber F2 decreases and accordingly it is possible to reduce the loss of TE light that is directed in the second EC 12. Accordingly, it is possible to reduce the loss of coupling between the second EC 12 and the second optical fiber F2 due to a deviation from a tolerance in dicing and realize an EC highly tolerant to the deviation from the tolerance in dicing.

The waveguide width of the third inversely taper portion 35A can be shorter than the waveguide width of the second inversely taper portion 35 illustrated in FIG. 2, which thus can contribute to a reduction in the size of the optical device.

As for the light chip 1 of Example 1, the case where the taper length of the second inversely taper portion 35 is longer than the taper length of the first inversely taper portion 25; however, the light chip is not limited to this and the embodiment thereof will be described as Example 5 below.

### (e) Example 5

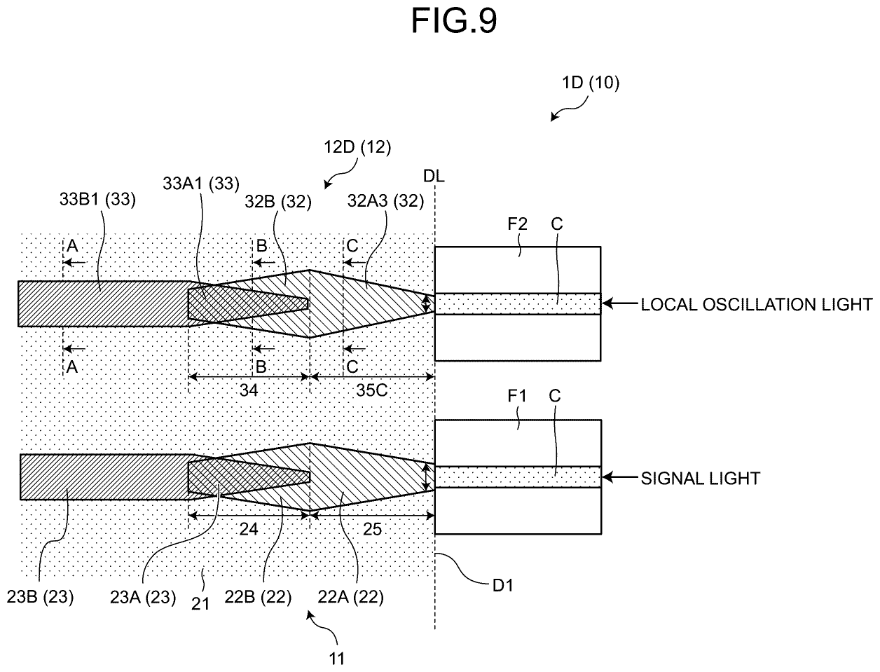

FIG. 9 is a plane schematic view illustrating an example of an EC portion in a light chip 1D of Example 5. Note that the same reference numerals are assigned to the same configuration as that of the light chip 1 of Example 1 and thus description of the redundant configuration and operations will be omitted. The light chip 1D of Example 5 is different from the light chip 1 of Example 1 in including a fourth inversely taper portion 35C instead of the second inversely taper portion 35.

While the taper length of the fourth inversely taper portion 35C is shorter than the taper length of the second inversely taper portion 35 illustrated in FIG. 2, the waveguide width of the fourth inversely taper portion 35C on the side of the chip end face D1 is narrower than that waveguide width of the first inversely taper portion 25 on the side of the chip end face D1. The waveguide width on the side of the chip end face D1 is the width of the tip of the inversely taper portion. As a result, the loss in coupling with the core C of the second optical fiber F2 decreases and accordingly it is possible to reduce the loss of TE light that is directed in the second EC 12. Accordingly, it is possible to reduce the loss in coupling between the second EC 12 and the second optical fiber F2 due to a deviation from a tolerance in dicing and realize an EC highly tolerant to the deviation from the tolerance in dicing.

Note that the case where the first waveguide, the second waveguide 23, the third waveguide, and the fourth waveguide 33 are channel waveguides has been exemplified; however, the waveguides are not limited to this and, for example, the waveguide may be a rib waveguide, a ridge waveguide, or a slab waveguide, and are changeable.

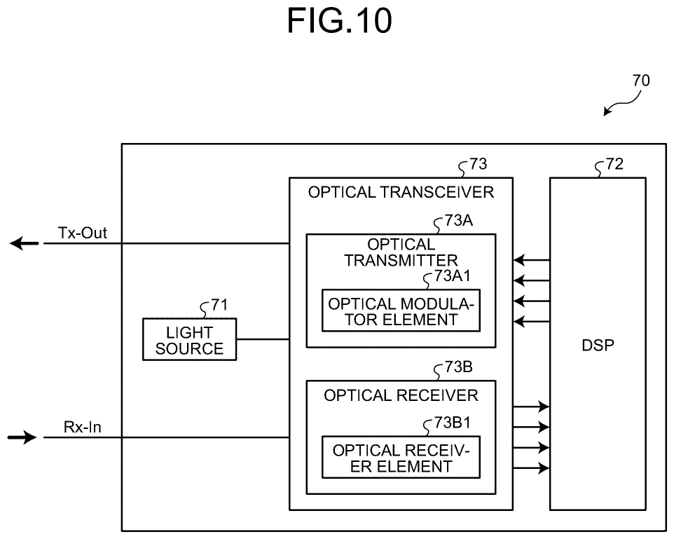

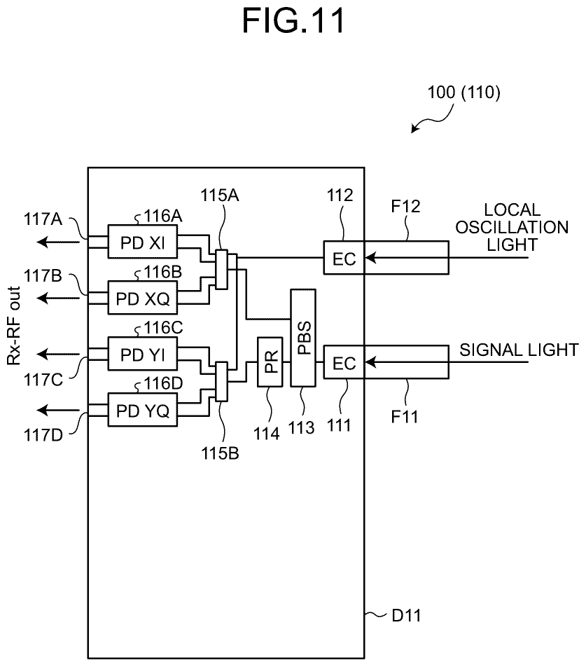

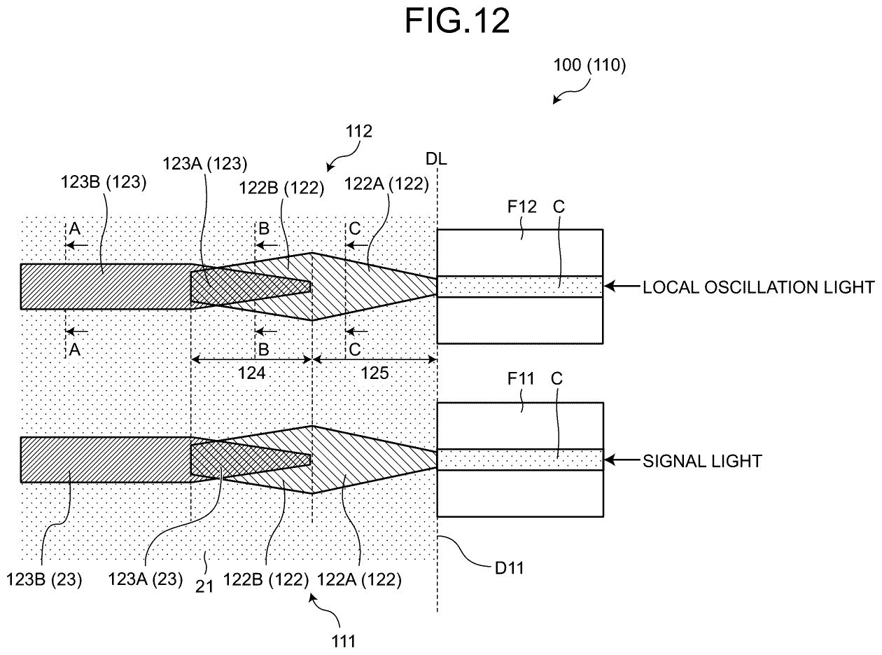

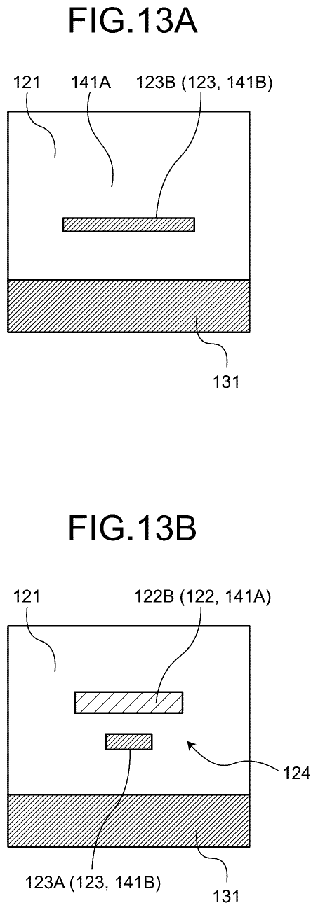

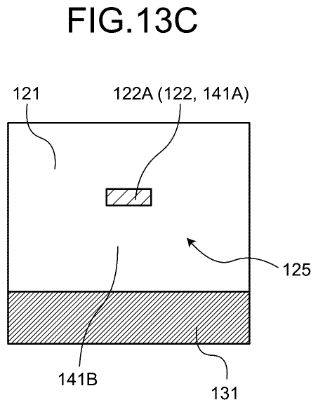

FIG. 10 is an illustration illustrating an example of an optical transceiver 70 of the present example. The optical transceiver 70 illustrated in FIG. 10 connects to an optical fiber on an output side and an optical fiber on an input side. The optical transceiver 70 includes a light source 71, a digital signal processor (DSP) 72, and an optical transceiver 73. The optical transceiver 73 includes an optical transmitter 73A and an optical receiver 73B. The DSP 72 is an electric part that executes digital signal processing. The DSP 72, for example, executes processing, such as coding transmission data, generates an electric signal containing the transmission data, and outputs the generated electric signal to the optical transmitter 73A. The DSP 72 receives an electric signal containing reception data from the optical receiver 73B and executes processing, such as decoding the acquired electric signal, thereby obtaining the reception data.

The light source 71, for example, includes a laser diode, generates light of a given wavelength, and supplies the light to the optical transmitter 73A and the optical receiver 73B. The optical transmitter 73A modulates light that is supplied from the light source 71 using the electric signal that is output from the DSP 72 and outputs the resultant transmission signal to an optical fiber. The optical transmitter 73A includes an optical modulator element 73A1 that generates transmission light by modulating the light supplied from the light source 71 using an electric signal that is input to the optical modulator when the light propagates through the waveguide.

The optical receiver 73B includes an optical receiver element 73B1 that receives a light signal from the optical fiber and demodulates the received light using the light that is supplied from the light source 71. The optical receiver 73B converts the demodulated received light into an electric signal and outputs the electric signal after the conversion to the DSP 72. The optical receiver 73B incorporates an optical device of a board-type optical waveguide device that directs light.

The optical device in the optical transceiver 70 includes a first EC that is connected to a polarization multiplexer-demultiplexer and that makes contact with a chip end face and a second EC that is connected to an optical hybrid circuit and that makes contact with the chip end face. The optical device includes a first taper portion that directs light from the optical fiber on the input side connecting to the chip end face and that is contained in the first EC and a second taper portion that directs light from the optical fiber connecting to the chip end face and connecting to the light source 71 and that is contained in a second edge coupler. The second taper portion has a structure in which a taper angle of the second taper portion with respect to the chip end face is smaller than a taper angle of the first taper portion with respect to the chip end face. As a result, the waveguide width of a second inversely taper portion on the side of the chip end face is narrower than the waveguide width of a first inversely taper portion on the side of the chip end face and accordingly a loss in coupling with the light source decreases, which makes it possible to reduce the loss of ET light that is directed in the second EC. Accordingly, it is possible to reduce the loss in coupling of the second EC 12 with the light source and the optical fiber due to a deviation from a tolerance in dicing and realize an EC highly tolerant to the deviation from the tolerance in dicing.

For convenience in description, the case where the optical transceiver 70 incorporates the optical transmitter 73A and the optical receiver 73B has been exemplified; however, the optical transceiver 70 may incorporate any one of the optical transmitter 73A and the optical receiver 73B. For example, the optical device may be applied to the optical transceiver 70 incorporating the optical receiver 73B and changes can be made as appropriate.

Each component of each unit illustrated in the drawings need not necessarily be configured physically as illustrated in the drawings. In other words, specific modes of distribution and integration of units are not limited to those illustrated in the drawings and all or part of the units can be configured by functional or physical distribution or integration in any unit according to various types of load and usage.

Furthermore, all or given part of various types of processing functions implemented by each device may be executed on a CPU (Central Processing Unit) (or a microcomputer, such as or a MPU (Micro Processing Unit) or a MCU (Micro Controller Unit)). Needless to say, all or any part of the various types of processing functions may be executed on a program that is analyzed and executed by the CPU (or a microcomputer, such as a MPU or a MCU) or on hardware according to a wired logic.

According to one aspect, it is possible to reduce a loss in coupling between a second edge coupler on a side of a local oscillation light port and an end face due to a deviation from a tolerance in dicing.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a first edge coupler that is connected to a polarization multiplexer-demultiplexer and that makes contact with an end face;
a second edge coupler that is connected to an optical hybrid circuit and that makes contact with the end face;
a first taper portion that directs light from the end face and that is contained in the first edge coupler; and
a second taper portion that directs light from the end face and that is contained in the second edge coupler,
wherein the second taper portion has a structure in which a taper angle of the second taper portion with respect to the end face is smaller than a taper angle of the first taper portion with respect to the end face.

2. The optical device according to claim 1, wherein the second taper portion has a structure in which a taper length of the second taper portion is longer than a taper length of the first taper portion.

3. The optical device according to claim 1, further including:
a first excess portion that connects to the first taper portion on a side of the end face; and
a second excess portion that connects to the second taper portion on the side of the end face,
wherein the second taper portion has a structure in which a waveguide width of the second taper portion on the side of the end face is narrower than a waveguide width of the first taper portion on the side of the end face.

4. The optical device according to claim 3, wherein the first excess portion has a structure in which a waveguide length of the first excess portion is shorter than a waveguide length of the second excess portion.

5. The optical device according to claim 1, wherein the second taper portion includes
a third taper portion that is arranged on a side of the end face; and
a fourth taper portion that optically connects to the third taper portion, and
the third taper portion has a structure in which a taper angle of the third taper portion with respect to the end face is smaller than a taper angle of the fourth taper portion with respect to the end face.

6. The optical device according to claim 1, wherein the first edge coupler inputs light from the end face as a signal light, and
the second edge coupler inputs light from the end face as local oscillation light.

7. The optical device according to claim 1, wherein the second edge coupler inputs light of which polarized state is transverse electric (TE) from the end face.

8. An optical receiver comprising an optical receiver element that converts signal light that is received into an electric signal, wherein
the optical receiver element includes
a first edge coupler that is connected to a polarization multiplexer-demultiplexer and that makes contact with an end face;
a second edge coupler that is connected to an optical hybrid circuit and that makes contact with the end face;
a first taper portion that directs light from the end face and that is contained in the first edge coupler; and
a second taper portion that directs light from the end face and that is contained in the second edge coupler, and
the second taper portion has a structure in which a taper angle of the second taper portion with respect to the end face is smaller than a taper angle of the first taper portion with respect to the end face.

9. An optical transceiver comprising:
an optical modulator element that modulates light that is directed according to an electric signal;
an optical receiver element that converts reception light that is received into an electric signal; and
a signal processor that generates an electric signal to the optical modulator element and that acquires the electric signal from the optical receiver element,
wherein the optical receiver element includes
a first edge coupler that is connected to a polarization multiplexer-demultiplexer and that makes contact with an end face;
a second edge coupler that is connected to an optical hybrid circuit and that makes contact with the end face;
a first taper portion that directs light from the end face and that is contained in the first edge coupler; and
a second taper portion that directs light from the end face and that is contained in the second edge coupler,
wherein the second taper portion has a structure in which a taper angle of the second taper portion with respect to the end face is smaller than a taper angle of the first taper portion with respect to the end face.
